(19) United States
(12) Patent Application Publication
(10) Pub. No.: US 2025/0388133 A1
(43) Pub. Date: Dec. 25, 2025

(54) Seat Position Control Device, Seat Position Control Method, and Vehicle

(71) Applicant: Bayerische Motoren Werke Aktiengesellschaft, Muenchen (DE)

(72) Inventors: Tobias BAUERNFEIND, Muenchen (DE); Wolfgang HABERL, Muenchen (DE); Alan KEIM, Hallbergmoos (DE); Manfred PAULI, Bruckberg (DE)

(21) Appl. No.: 19/214,146

(22) Filed: May 21, 2025

(30) Foreign Application Priority Data
Jun. 21, 2024 (DE) 10 2024 117 572.9

(51) Int. Cl. B60N 2/02

(52) U.S. Cl. CPC B60N 2/0268; B60N 2/0239

(57) ABSTRACT

A seat position control device for automatically adjusting the seat position of at least one occupant in a vehicle includes a sensor device configured to detect an action of the occupant for starting a media content on smart glasses and subsequently a seat position intention of the at least one occupant, a control device configured to process the data of the sensor device and to adjust the seat position of the at least one occupant to a predefined seat position based on the processed data. Also disclosed is a seat position control method and a vehicle with the seat position control device.

### CROSS REFERENCE TO RELATED APPLICATION

This application claims priority under 35 U.S.C. § 119 from German Patent Application No. 10 2024 117 572.9, filed Jun. 21, 2024, the entire disclosure of which is herein expressly incorporated by reference.

### BACKGROUND AND SUMMARY

The present invention relates to a seat position control device, a seat position control method, and a vehicle.

In today's fast-paced world, where mobility and multitasking are increasingly important, comfort in vehicles, especially when using modern media technologies, is of central importance. An increasing number of vehicle users are demanding improved options for entertainment and information retrieval while driving, particularly in terms of comfort and ergonomics when using smart glasses.

Current vehicle systems offer various entertainment options, but they are often not optimally adapted for use with smart glasses. For example, when viewing media content via smart glasses that are superimposed on the user's field of vision, various problems and challenges arise. Current systems often fail to take into account the ergonomic needs of the user, which can lead to an unnatural posture, increased fatigue and, as a result, reduced riding comfort.

The ergonomic design of the seat position in vehicles is often static and not flexible enough to meet the changing requirements of visual comfort when viewing media via smart glasses. Drivers and passengers often have to get into uncomfortable positions in order to see content clearly, which can lead to tension and discomfort, especially on longer journeys.

In addition, manual adjustment of the seat position, which is often necessary to ensure a comfortable view, is not only impractical while driving, but also critical to safety.

One object of the present invention can be seen in providing an improved seat position control device, an improved seat position control method, and an improved vehicle.

This task is solved by a seat position control device, a seat position control method, and a vehicle with the characteristics of the independent claims.

According to the invention, the following is provided:

A seat position control device for automatically adjusting the seat position of at least one occupant in a vehicle, comprising a sensor device adapted to detect an action of the occupant to start a media content on smart glasses and subsequently a seat position intention of the at least one occupant; a control device adapted to process the data from the sensor device and to adjust the seat position of the at least one occupant to a predefined seat position based on the processed data.

Further provided is a seat position control method for automatically adjusting the seat position of at least one occupant in a vehicle, comprising the following steps: detecting a seat position intention of the at least one occupant, which comprises an action of the occupant to start a media content on smart glasses, by means of a sensor device; processing the data of the sensor device by a control device and adjusting the seat position of the at least one occupant to a predefined seat position based on the processed data.

Further provided is a vehicle with a seat position control device according to the invention.

The seat position control device in a vehicle according to the invention is intended to automatically adjust the seat position of one or more occupants to increase both comfort and functionality. This is achieved through a combination of a sensor device and a control device that work together seamlessly to enhance the user experience.

In the invention described, “smart glasses” are defined as a wearable, technologically advanced device that may have built-in display capabilities, the ability to interact with various digital systems, ultra-wideband (UWB) technology, and/or position sensors.

Smart glasses contain one or more small display devices. These display devices can project information directly into the user's field of vision, enabling augmented reality (AR) or virtual reality (VR), for example. This information can include, for example, the current seat position, available media content, and setting options.

The smart glasses are equipped with sensors and input devices that enable interaction with the seat position control device. This can be done using voice commands, touchpads on the glasses, or gesture recognition. The glasses can therefore receive commands and forward them to the vehicle system for execution.

The smart glasses have the necessary connectivity (e.g., Bluetooth, UWB, WiFi) to communicate with other devices in the vehicle, such as the seat position control device. This networking makes it possible to change settings synchronously and control media content.

The smart glasses could also be referred to as “augmented reality glasses”, “data glasses”, or “interactive glasses”. These terms emphasize the ability of the glasses to overlay digital data at least partially over the physical world and to provide an interface for the interaction and control of digital processes.

In this disclosure, the term “media content” refers to various forms of digital data and information that can be transmitted and displayed in a vehicle. This content is used to entertain, inform, and/or interact with the occupants while driving or when stationary. The integration of this content through the smart glasses and the seat position control device is intended to personalize and enrich the driving experience.

The “seat position” feature refers to the configuration and orientation of a vehicle seat that can be adjusted to maximize occupant comfort, ergonomics, and/or safety. Adjusting the seat position can involve many aspects, including the angle of the backrest, the height of the seat, the position of the headrest, the length of the seat (to support the thighs), and/or the position of armrests.

When watching a movie, the seat position could be automatically adjusted to a reclining position, which is similar to a relaxing position. This could be achieved by moving the seat back and reclining the backrest to allow a more comfortable view of the smart glasses.

The headrest could be adjusted so that it provides optimum support for the head while looking forwards or towards a sun visor, for example. The sun visor could be used, for example, as a background or as a projection screen for viewing media content using the smart glasses.

For reading or using a computer user interface, the seat could be adjusted to an upright position that promotes a healthy posture. The seat could be pushed forward and the backrest could be moved to a less inclined position to maximize back support. In addition, the height of the seat could be adjusted to ensure that the occupant's feet rest flat on the floor, which is ergonomically advantageous.

While driving, the seat position could be dynamically adjusted to increase safety and comfort, especially when cornering or braking. The seat's side supports could adjust automatically to better support the occupant and prevent them from sliding in the seat.

These adjustments can be controlled via manual controls, voice commands, or automated scenarios that are activated by detecting the occupant's activities via sensors in the smart glasses or in the vehicle. State-of-the-art vehicles use advanced algorithms and sensors to ensure the best possible comfort and ergonomics for occupants in different circumstances.

The primary task of the sensor device is to recognize specific actions of the occupant that indicate an intention to change the seat position. This begins with an action such as starting media content on smart glasses.

After starting the media content, the device detects further signals that could indicate a desired change in the seat position. These can be simple gestures, touches, and/or specific glances that are detected by the sensor device and/or the smart glasses.

The data collected by the sensor device is transmitted to the control device. This control device analyzes the data in order to interpret the occupant's intentions with regard to their preferred seat position.

The control device then automatically adjusts the seat position based on the analyzed data. This adjustment is carried out in such a way that it is tailored to the specific activity of the occupant, such as watching media.

Automatic adjustment of the seat position according to the occupant's activities ensures optimum comfort. When watching movies and/or relaxing, for example, the seat can be adjusted to a reclined position, which is easier on the back and improves the experience.

By automatically adjusting the seat position, safety in the vehicle can be increased. An optimal seat position can help reduce occupant fatigue and improve ergonomic support, which is particularly important on longer journeys.

The use of intuitive gestures and actions to control the seat position makes operation easier and more natural. Eliminating manual settings and/or complicated operating instructions increases the user-friendliness and accessibility of the technology.

The technology allows seat positions to be individually adjusted based on the personal preferences and needs of the occupants. This increases not only the comfort, but also the satisfaction of the occupants.

Rapid, precise adjustment of seat positions, controlled by advanced algorithms, saves time and minimizes errors during manual adjustment. This leads to more efficient use of vehicle functions.

This technology can potentially be networked with other intelligent systems in the vehicle, such as ambient light control and air conditioning, to create a comprehensive experience that automatically adapts to the occupant's needs.

Overall, this invention provides an innovative solution to improve vehicle utilization by automating functions that would traditionally require manual intervention, thereby elevating occupant-vehicle interaction to new levels of convenience and efficiency.

According to a preferred embodiment, a seat position control device can comprise a sensor device adapted to detect the seat position intention of an occupant by specific actions, such as folding down a sun visor and/or touching a contact on said sun visor.

In this preferred embodiment, the sensor device is designed so that it not only reacts to digital interactions (such as the use of smart glasses), but can also use physical actions of the occupant as control signals. Folding down a sun visor and/or touching a contact on said sun visor are examples of actions that can be used as triggers for the sensor device.

The sensor device may use sensors or switches integrated into the sun visor to detect these actions. Such sensors could be capacitive, resistive, and/or mechanical switches that react to touch and/or movement.

Once the sensor device detects one of the specified actions, it sends a signal to the control device. The control device is programmed to interpret the detected actions and adjust the occupant's seat position accordingly.

The adjustment can be intended to optimize the seat position for the use of sun visors while driving, for example by reclining the seat slightly to reduce glare and increase comfort.

The ability to use simple physical interactions to control the seat position improves the intuitiveness of the controls. Occupants need not deal with complex digital interfaces, but can use natural, everyday actions.

This type of control is particularly advantageous for users who are less familiar with digital devices or have a preference for haptic operation.

By automating seat position adjustment based on physical actions that are typical while driving, such as adjusting the sun visor, safety can be increased. The occupant has to make fewer manual adjustments, which leads to less distraction.

The detection of specific actions enables a more differentiated adjustment of the seat position, which can be adapted to the specific situation and the needs of the occupant.

This embodiment of the invention thus offers an extended, user-friendly, efficient way of adjusting the seat position, improving both general ergonomics and safety in the vehicle.

According to a preferred embodiment, a seat position control device can include a sensor device that is designed to detect the seat position intention of an occupant based on their movement profile and/or gestures using an interior camera and/or the smart glasses.

The sensor device in this embodiment is equipped with technologies capable of recognizing and interpreting the physical movements and/or gestures of the occupants. Interior cameras and/or sensors in smart glasses continuously record data about the occupant's activities in the vehicle.

For example, the camera can detect head movements, hand gestures, and/or general body posture, while the smart glasses can detect specific glances or eye movements, for example, a glance at the sun visor.

The collected data is analyzed by the control device to detect patterns or specific gestures that indicate an intention to change the occupant's seat position. Software that processes this data uses machine learning or pattern recognition algorithms, for example, to precisely interpret the occupant's intentions.

The control device automatically adjusts the occupant's seat position based on the detected seat position intention. This is achieved by actuators in the seat that modify the position according to the recognized gestures and movement profiles.

Using gestures and movement profiles to control the seat position makes interaction with the vehicle more intuitive and natural. This reduces the need for physical buttons and switches and enables hands-free operation, which is particularly beneficial when driving.

The technology also enables a high degree of personalization of the seating experience. The seat can respond to subtle nuances in the occupant's movements and gestures, allowing for a customized and therefore more comfortable ride.

By automatically adjusting the seat position based on the occupant's natural movements, the risk of distractions can be reduced.

The integration of interior cameras and/or smart glasses makes it possible to seamlessly integrate the seat position control device into a comprehensive system of vehicle assistance technologies. This promotes the development towards fully networked, intelligent vehicles.

This embodiment of the invention thus represents a significant advancement in the way occupants can interact with their vehicle. It not only improves comfort and safety, but also adapts vehicle use to modern technology trends and users' expectations of intuitive operation.

According to a preferred embodiment, a seat position control device can be designed such that the predefined seat position is a relaxed or movie position, which comprises a position of the seat that is optimized for viewing media content.

The embodiment of the seat position control device described focuses on optimizing the seating experience for media consumption in the vehicle. A specific seat configuration setting, known as the relaxed or movie position, is used to provide maximum comfort when watching media content.

The seat position control device is preferably designed in such a way that it activates a predefined seat position that is specially designed for viewing media content. This position could include, for example, a more reclined seat angle, a raised footrest and/or an adapted headrest.

This position can be activated automatically based on the detection of media playback on smart glasses.

The device's control unit contains the logic and parameters for adjusting the seat to the relaxed or movie position. These settings are defined and optimized in advance to ensure the best possible comfort and view of the screen.

The seat is adjusted in particular by electrical and/or mechanical actuators that can move various parts of the seat to achieve the desired position.

The special configuration of the seat for viewing media contributes significantly to increased comfort. The ergonomic design reduces fatigue and increases overall occupant satisfaction during extended periods of media consumption.

An appropriate sitting position can reduce strain on the body and promote ergonomic health. By optimizing the seat position specifically for viewing media, the device helps to minimize the neck and eye strain often associated with poor posture and awkward viewing angles.

The simple activation of the predefined seat position by recognizing the media playback makes operation user-friendly and intuitive. Occupants can easily switch between normal driving positions and the relaxed or movie position.

The ability to adjust the seat position according to the occupant's activity increases the flexibility of the vehicle interior. This adaptability is particularly useful in vehicles that could be used as mobile entertainment centers and/or as part of an autonomous vehicle fleet concept.

The integration of such technological comfort features can increase the overall value and appeal of the vehicle, especially for customers who value luxury and advanced vehicle technologies.

In summary, this embodiment of the seat position control device offers significant advantages in terms of comfort, safety, ease of use, and adaptability, making it a valuable addition to any modern vehicle, especially at a time when media consumption is becoming increasingly relevant on the move.

According to a preferred embodiment, a seat position control device may include a programmable control device that can store and automatically adjust various relaxed and movie positions according to the occupant's individual preferences.

This embodiment of the seat position control device extends its functionality by integrating a programmable control device that is able to store different seat positions and automatically adjust them according to the individual preferences of each occupant. This functionality is specifically designed to meet the needs of occupants who want to personalize their seating experience.

The control unit of this seat position control device is equipped with a digital memory and software that makes it possible to store individual seat positions. These positions can be preset or adjusted by the occupant based on personal preferences for different situations such as relaxing, working with computers, reading books, or watching movies.

The control unit processes the stored data and controls the components of the seat to automatically set the desired position.

The ability to save and automatically adjust different seat positions enables a high degree of personalization of comfort in the vehicle. Occupants can save their preferred settings for different activities, enhancing the driving experience.

The simple operation of the control unit also increases accessibility and user-friendliness. Occupants need not make manual adjustments each time, but can choose from pre-programmed positions or adjust them with minimal effort.

Automatic adjustment of the seat position saves time, especially if the vehicle user changes frequently. Seat positions can be adjusted quickly and efficiently without the occupant having to make any manual adjustments.

The seat position control can be adjusted for a wide range of body types and preferences, making it ideal for vehicles used by multiple people. This is particularly useful in family vehicles or vehicles used in commercial fleets.

In summary, this embodiment offers significant advantages in terms of personalization, comfort, safety, and ease of use due to its ability to store and automatically adjust different relaxed and movie positions, making the vehicle significantly more attractive to users who value a highly individualized driving experience.

According to a preferred embodiment, a seat position control device can be designed in such a way that it can return the seat position of the at least one occupant to a normal seat position by moving the sun visor in the opposite direction and/or by voice control.

The embodiment of the seat position control device, which provides the ability to reset an occupant's seat position to a normal seat position by opposite movement of the sun visor and/or by voice control, integrates advanced interaction methods with the aim of making use more intuitive and safer. These functions are specifically designed to improve comfort and user-friendliness in vehicle operation.

The seat position control device uses mechanical and/or electronic sensors integrated into the sun visor to detect an opposing movement. This movement is used as a signal to automatically reset the seat position from a previously set relaxed or movie position to a normal seat position that is more suitable for driving.

This function can be particularly useful if the occupant wants to prepare the vehicle for normal driving activities at the end of a break or after watching media.

These functions make it easier to interact with the vehicle system, especially in situations where manual settings would be difficult or impractical.

These functionalities can be easily integrated into existing vehicle electronics systems, which increases the adaptability of the technology to different vehicle models and brands.

In summary, this embodiment of the seat position control device provides increased safety, ease of use, and improved comfort through the implementation of gesture-based and voice-activated customization capabilities, making it a valuable addition to any modern vehicle.

According to a preferred embodiment, a seat position control device can be designed to simultaneously display different media content for different occupants and to adjust the respective seat position of each occupant.

This specific design of the seat position control device is characterized by an innovative integration of media technology and personalized seat adjustment. It is designed to offer different occupants different media content at the same time and to individually adjust the seat position of each occupant accordingly. This functionality offers significant advantages for the personalization of driving experience and comfort.

For example, the seat position control device can connect to an advanced multimedia system that is able to offer different media content simultaneously on a variety of smart glasses. Each occupant can select and play their own media content without disturbing the others.

The seat position control device is programmed to automatically adjust the seat position of each occupant based on the media content selected. For example, the seat could be moved to a more relaxed position for watching a movie or to a more upright position for reading or working.

The ability to automatically adjust the seat position based on individual activities significantly improves the personal comfort of each occupant. This contributes to an improved user experience, especially on long journeys.

Increased satisfaction and user-friendliness:

Allowing every occupant to enjoy their favorite media content independently of others increases overall occupant satisfaction. This is particularly advantageous for families or groups with different entertainment preferences.

Individual media output minimizes conflicts and distractions that can arise when occupants are forced to share the same content. This contributes to safety by reducing driver distraction.

The integration of advanced media technology and automated seat control promotes a modern and technologically advanced vehicle concept. This can increase the attractiveness of the vehicle on the market and make it more appealing to tech-savvy buyers.

The technology offers flexibility and scalability for different vehicle types and classes, allowing vehicle manufacturers to offer it in a wide range of models.

In summary, this embodiment of the seat position control device provides an outstanding improvement to the passenger experience by combining personalized media consumption and automated seat adjustment. It increases the comfort, satisfaction, and safety of the occupants while also helping to strengthen the vehicle's technological leadership position on the market.

According to a preferred embodiment, a seat position control device may comprise a control device that provides a user interface on the smart glasses for manually adjusting the seat position or selecting media content.

The described embodiment of the seat position control device integrates the use of smart glasses to provide an innovative user interface. This user interface allows the user to manually adjust the seat position and/or select media content. This technology expands the interaction possibilities in the vehicle and offers numerous advantages for the user experience.

The seat position control device is connected to the smart glasses, which serve as a display and input device. Through these glasses, the user can directly access a user interface that provides visual information about the current seat position as well as options for adjusting and selecting media content.

Users can adjust the seat position directly via the smart glasses by tapping on virtual buttons or menus or interacting using gesture control. This enables precise and individual adjustment of the seat tilt, backrest, headrest, and other adjustable elements of the seat.

Users can select and play media content via the same user interface. This can include the control of music, videos, messages, and other digital media accessible via the vehicle system or external devices.

The integration of smart glasses with an interactive user interface makes control more intuitive and accessible. This promotes a seamless user experience by simplifying operation and allowing users to make settings without having to operate physical switches or screens in the vehicle.

The ability to manually adjust seat positions and individually select media content offers a high degree of personalization. Users can customize their driving experience according to their specific needs and preferences, increasing comfort and satisfaction while driving.

In summary, this embodiment of the seat position control device provides an advanced, user-centered interface that puts control of seat positions and media content directly in the hands of the user. This solution promotes ease of use, safety, and personalization, making it a valuable addition to any modern vehicle.

The vehicle can be a car, a truck, a bus, an airplane, or a ship, for example.

The present invention is explained in more detail below with reference to the embodiments shown in the schematic figures in the drawings.

### BRIEF DESCRIPTION OF THE DRAWINGS

FIG. 1 shows a schematic block diagram of an embodiment of the seat position control device according to the invention

FIG. 2 shows a schematic flow chart of an embodiment of a seat position control method according to the invention.

FIG. 3 shows a schematic flow chart of a further example embodiment of a seat position control method according to the invention.

FIG. 4 shows a schematic top view of an embodiment of a vehicle according to the invention.

### DETAILED DESCRIPTION OF THE DRAWINGS

Where appropriate, the embodiments and further developments described can be combined with one another as desired.

Further possible embodiments, refinements, and implementations of the invention could also comprise combinations of features of the invention not explicitly mentioned above or described below with respect to the embodiments.

The accompanying drawings are intended to provide a further understanding of the embodiments of the invention. They illustrate embodiments and, in connection with the description, serve to explain principles and concepts of the invention.

Other embodiments and many of the advantages mentioned may be apparent from the drawings.

The elements in the drawings are not necessarily shown to scale. Identical reference numbers denote identical or similar components.

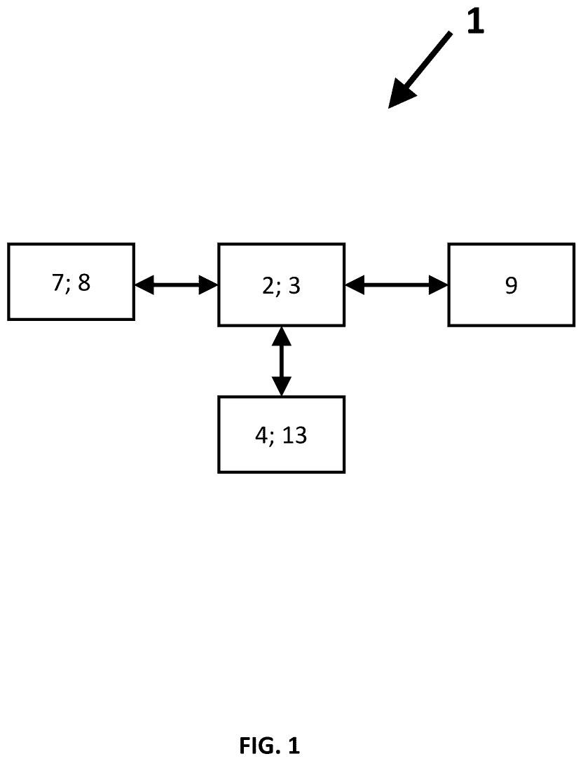

FIG. 1 shows a schematic block diagram of one embodiment of the seat position control device 1 according to the invention. The seat position control device 1 comprises a sensor device 2 and a control device 9. The sensor device 2 is designed in such a way that it detects an action of the occupant 13 to start a media content on smart glasses 4 and then identifies the seat position intention of this occupant 13. Based on the data recorded, the control device 9 adjusts the seat position of occupant 13 to a predefined position.

The sensor device 2 can detect the seat position intention of the occupant 13 by specific actions such as folding down a sun visor 7 or touching a contact 8 on this sun visor. Furthermore, the sensor device 2 can detect the seat position intention based on the movement profile and/or gestures of the occupant 13 using an interior camera 3 and/or the smart glasses 4.

It is also possible for the predefined sitting position to be a relaxed or movie position that is specially optimized for viewing media content. The control device 9 can also be programmable to store and automatically adjust different relaxed and movie positions according to the individual preferences of the occupant 13.

Furthermore, the seat position control device 1 can be designed in such a way that it can return the seat position of the occupant 13 to a normal seat position by moving the sun visor 7 in the opposite direction or by voice control. The seat position control device 1 can display different media content for different occupants 13 and adjust the respective seat position of each occupant 13.

Another optional feature is that the control device 9 provides a user interface on the smart glasses 4 that allows the occupant 13 to manually adjust the seat position and/or select media content. These functions increase the flexibility and comfort of the seat position control device 1 by enabling a more individual and interactive user experience.

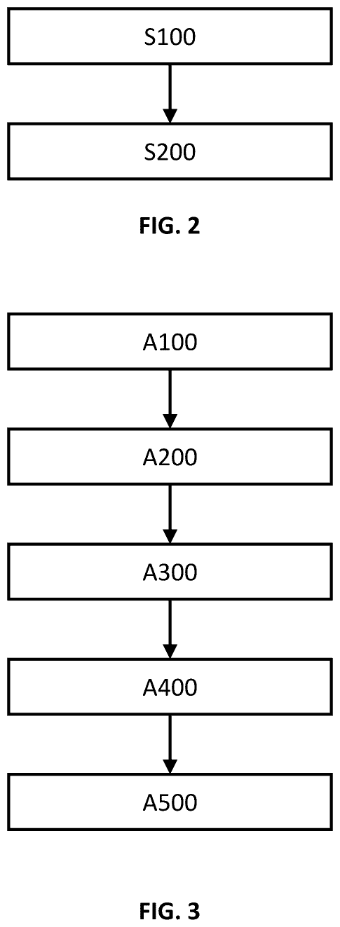

FIG. 2 shows a schematic flow chart of an embodiment of a seat position control method according to the invention for automatically adjusting the seat position of at least one occupant 13 in a vehicle 100. The seat position control method comprises the following steps:
S100: Detect a seat position intention of the at least one occupant 13, which comprises an action of the occupant 13 to start a media content on a smart glasses 4, by means of a sensor device 2,
S200: Process the data from the sensor device 2 by means of a control device 9 and adjust of the seat position of the at least one occupant 13 to a predefined seat position based on the processed data.

FIG. 3 shows a schematic flow chart of a further exemplary embodiment of a seat position control method according to the invention. This embodiment of the seat position control method according to the invention for automatically adjusting the seat position of an occupant 13 in a vehicle 100 could comprise the following five steps.
A100: The sensor device 2 in the vehicle 100 detects the start of media content on smart glasses 4. This signal is used as a trigger for the seat position control method. The smart glasses 4 preferably communicate wirelessly with the sensor device 2 and signal the start of media playback.
A200: After starting the media content, the sensor device 2 can detect additional signals that indicate a desired change in the seat position of the occupant 13. This could be done, for example, by folding down a sun visor, recognizing gestures such as the occupant 13 leaning back and/or touching a specially designed control element on the smart glasses 4, on the seat, and/or on the sun visor.
A300: The recorded data is forwarded to the control device 9, which analyzes the information. The control device 9 takes into account the type of media content started—for example, a more relaxed, lying position might be ideal for a film—as well as the recognized user gestures.
A400: Based on the analysis of the data, the control device 9 automatically adjusts the seat position of the occupant 13. This includes mechanical adjustments such as changing the tilt angle of the seat, moving the seat surface, and/or adjusting the headrest to ensure maximum comfort for viewing media content.
A500: After the initial adjustment of the seat position, the occupant 13 could provide feedback via the smart glasses 4 as to whether the set position is comfortable or requires further adjustments. The control device 9 can then make fine adjustments to ensure the perfect position. This could be done via a simple user interface on the smart glasses 4, through which the occupant 13 can manually refine settings.

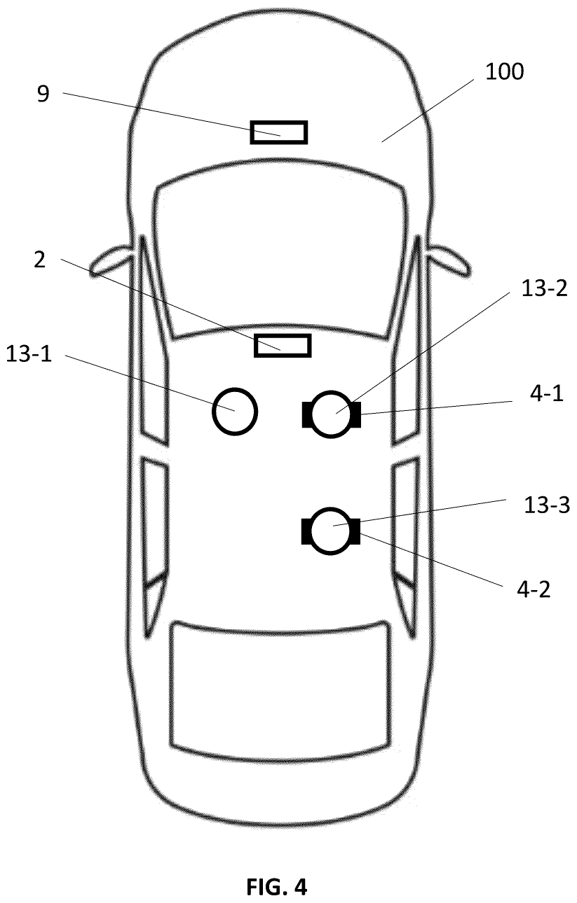

FIG. 4 shows a schematic top view of an embodiment of a vehicle 100 according to the invention. The vehicle 100 equipped with the seat position control device 1 according to the invention is technologically designed to improve comfort and interactivity for the occupants 13-1; 13-2; 13-3. This is achieved by adjusting the seat position based on individual activities such as the consumption of media content.

A sensor device 2 is provided in the vehicle 100 which may have various sensors that can detect different actions and states of the occupants 13-1; 13-2; 13-3, including motion sensors, gesture recognition sensors, and touch-sensitive surfaces. The sensor device 2 detects the launching of media content via smart glasses 4; 4-1; 4-2, physical movements, and/or gestures of the occupants 13-1; 13-2; 13-3.

The control device 9 processes the data collected by the sensor device 2 and controls the mechanical systems to adjust the seat positions according to the detected needs of the occupants 13-1; 13-2; 13-3.

The occupants 13-2; 13-3 each wear smart glasses 4-1; 4-2, which have, for example, augmented reality functions and/or virtual reality functions. These smart glasses 4-1; 4-2 can display media content, enable interactions, and/or communicate with the seat position control device 1 of the vehicle 100.

The smart glasses 4-1; 4-2 are connected to the seat position control device 1 of the vehicle 100, for example, via wireless technologies such as Bluetooth, UWB, and/or Wi-Fi. This enables seamless communication and interaction between the occupants 13-1; 13-2; 13-3 and the seat position control device 1 of the vehicle 100.

Suppose occupant 13-2 wants to watch a movie and puts on his smart glasses 4-1. The smart glasses 4-1 start the movie and send a signal to the sensor device 2 of the vehicle 100. Occupant 13-3 wants to read an e-book at the same time and starts a reading app via his smart glasses 4-2.

The sensor device 2 detects the intention of the occupant 13-2 to watch a movie. The control device 9 processes this information and automatically adjusts the seat of occupant 13-2 to a relaxed or movie position. This position could include a reclined backrest and possibly a raised leg rest to provide an optimal view of the contents of the smart glasses 4-1 and maximize comfort.

The sensor device 2 also detects the reading activity of the occupant 13-2. The control device 9 then adjusts the seat of occupant 13-2 to an upright position that makes reading easier. The lighting near the seat could also be adjusted to provide better lighting for reading.

During media consumption, both occupants 13-2; 13-3 can manually refine settings via their smart glasses 4-1; 4.2. For example, occupant 13-1 could decide to recline the backrest even further and can set this directly via a user interface on the smart glasses 4.

Occupants 13-2; 13-3 could also change the seat position using voice commands, which is particularly useful if they want to keep their hands free.

Such a vehicle 100 would be ultra-modern and designed to personalize and enhance the driving experience through technological integration and automation. The individual preferences and activities of each occupant 13-1, 13-2, 13-3 are taken into account to ensure that each occupant 13-1, 13-2, 13-3 enjoys the highest possible level of comfort and support while driving. The integration of smart technology allows occupants 13-1, 13-2, 13-3 to intuitively control and adjust their seat positions and surroundings, making the ride not only more comfortable, but also more entertaining.

### REFERENCE NUMBER LIST

1 Seat position control device
2 Sensor device
3 Interior camera
4 Smart glasses
4-1 Smart glasses
4-2 Smart glasses
7 Sun visor
8 Contact on the sun visor
9 Control device
13 Occupant
13-1 Occupant
13-2 Occupant
13-3 Occupant
100 Vehicle
S100 Process step
S200 Process step
A100 Process step
A200 Process step
A300 Process step
A400 Process step
A500 Process step

What is claimed is:

1. A seat position control device for automatically adjusting a seat position of at least one occupant in a vehicle, the seat position control device comprising:
a sensor device configured to detect an action of the occupant for starting a media content on smart glasses and subsequently detect a seat position intention of the at least one occupant; and
a control device configured to process data from the sensor device and adjust the seat position of the at least one occupant to a predefined seat position based on the processed data.

2. The seat position control device according to claim 1, wherein the sensor device is configured to detect the seat position intention of the occupant based on specific actions including folding down a sun visor or touching a contact on the sun visor.

3. The seat position control device according to claim 1, wherein the sensor device is configured to detect the seat position intention of the occupant based on their movement profile and/or gestures via an interior camera and/or the smart glasses.

4. The seat position control device according to claim 2, wherein the sensor device is configured to detect the seat position intention of the occupant based on their movement profile and/or gestures via an interior camera and/or the smart glasses.

5. The seat position control device according to claim 1, wherein the predefined seat position is a relaxed or movie position, which comprises a position of the seat that is optimized for viewing media content.

6. The seat position control device according to claim 2, wherein the predefined seat position is a relaxed or movie position, which comprises a position of the seat that is optimized for viewing media content.

7. The seat position control device according to claim 3, wherein the predefined seat position is a relaxed or movie position, which comprises a position of the seat that is optimized for viewing media content.

8. The seat position control device according to claim 1, wherein the control device is programmable to store and automatically adjust different relaxed and movie positions according to individual preferences of the occupant.

9. The seat position control device according to claim 2, wherein the control device is programmable to store and automatically adjust different relaxed and movie positions according to individual preferences of the occupant.

10. The seat position control device according to claim 3, wherein the control device is programmable to store and automatically adjust different relaxed and movie positions according to individual preferences of the occupant.

11. The seat position control device according to claim 1, wherein the seat position control device is configured to adjust the seat position of the at least one occupant back to a normal seat position by an opposing movement of the sun visor and/or by voice control.

12. The seat position control device according to claim 2, wherein the seat position control device is configured to adjust the seat position of the at least one occupant back to a normal seat position by an opposing movement of the sun visor and/or by voice control.

13. The seat position control device according to claim 3, wherein the seat position control device is configured to adjust the seat position of the at least one occupant back to a normal seat position by an opposing movement of the sun visor and/or by voice control.

14. The seat position control device according to claim 1, wherein the seat position control device is configured to simultaneously display different media content for different occupants and to adjust a respective seat position of each occupant.

15. The seat position control device according to claim 2, wherein the seat position control device is configured to simultaneously display different media content for different occupants and to adjust a respective seat position of each occupant.

16. The seat position control device according to claim 3, wherein the seat position control device is configured to simultaneously display different media content for different occupants and to adjust a respective seat position of each occupant.

17. The seat position control device according to claim 1, wherein the control device provides a user interface on the smart glasses for manually adjusting the seat position and/or for selecting media content.

18. The seat position control device according to claim 2, wherein the control device provides a user interface on the smart glasses for manually adjusting the seat position and/or for selecting media content.

19. A seat position control method for automatically adjusting a seat position of at least one occupant in a vehicle, the method comprising:
detecting a seat position intention of the at least one occupant, which includes an action of the occupant to start a media content on smart glasses, via a sensor device;
processing data from the sensor device by a control device and adjusting the seat position of the at least one occupant to a predefined seat position based on the processed data.

20. A vehicle comprising a seat position control device according to claim 1.
